(19) United States
(12) Patent Application Publication
(10) Pub. No.: US 2009/0184511 A1
(43) Pub. Date: Jul. 23, 2009

(54) Advertising Device With Slider

(75) Inventor: Murray Kirk, Toronto (CA)

Correspondence Address: Lawrence A. Aaronson, P.C.;Lawrence A. Aaronson, 12850 Highway 9, Suite #600 PMB 338, Alpharetta, GA, 30004, US

(73) Assignee: INFORMATION PACKAGING INC., Toronto (CA)

(21) Appl. No.: 12/273,480

(22) Filed: Nov. 18, 2008

Related U.S. Application Data
(60) Provisional application No. 61/006,559, filed on Jan. 22, 2008.

(51) Int. Cl. B42D 15/00; B65D 27/04; B65D 27/00

(52) U.S. Cl. 283/99; 283/56; 229/71; 229/75

(57) ABSTRACT

An advertising device includes an envelope having a front panel and a back panel, the front panel including an envelope window dimensioned to reveal first advertising information on an interior wall of the back panel. A slider is slidably disposed in the envelope and has a slider window that is dimensioned to reveal only a portion of the first advertising information depending upon its position in the envelope. The slider is moveable by a user of the advertising device.

### FIELD OF THE INVENTION

The device disclosed herein relates generally to advertising devices and promotional items, and more particularly to an advertising device and a one-piece blank for manufacturing the same.

### BACKGROUND OF THE INVENTION

Advertising devices and promotional items such as brochures and other takeaway items for carrying print and image information are well known and useful for conveying the information in an attractive and compact package. While portable print advertising devices are known, improvements are of course desired in order to provide devices that convey the information in a new and attractive ways, and to further provide simple and cost-effective means for producing such devices. It is an object to provide a novel print advertising device herein.

### SUMMARY OF THE INVENTION

In accordance with an aspect, there is provided an advertising device comprising:

an envelope having a front panel and a back panel, the front panel including an envelope window dimensioned to reveal first advertising information on an interior wall of the back panel;

a slider slidably disposed in the envelope and having a slider window dimensioned to reveal only a portion of the first advertising information depending upon its position in the envelope;

wherein the slider is moveable by a user of the advertising device.

In accordance with another aspect, there is provided an elongate, foldable blank for an advertising device, comprising:

a first generally rectangular panel having a first end edge and a second end edge opposite the first end edge, the first panel having an envelope window therethrough;

a second generally rectangular panel having a first end edge connected to the second end edge of the first rectangular panel by a fold line, and a second end edge, the second panel having advertising information thereon;

a third rectangular panel a first end edge connected to the second end edge of the second rectangular panel by a fold line, and a second end edge, the third panel comprising a slider portion disposed between two spacer portions, the slider portion having a slider window and adapted to be decoupled from the spacer portions during manufacture of the advertising device;

wherein the first, second and third panels have corresponding exterior dimensions and are adapted to be folded together in such a manner as to generally form an envelope inside of which the slider portion may be moved to thereby selectively reveal a portion of the advertising information on the second panel through both the envelope and slider windows.

According to still another aspect, there is provided a method of manufacturing an advertising device, comprising:

providing an elongate, foldable blank comprising:
a first generally rectangular panel having a first end edge and a second end edge opposite the first end edge, the first panel having an envelope window therethrough;
a second generally rectangular panel having a first end edge connected to the second end edge of the first rectangular panel by a fold line, and a second end edge, the second panel having advertising information thereon;
a third rectangular panel a first end edge connected to the second end edge of the second rectangular panel by a fold line, and a second end edge, the third panel comprising a slider portion disposed between two spacer portions, the slider portion having a slider window;

decoupling the slider portion from the spacer portions;

folding the third panel over the second panel including adhering the spacer portions to the second panel;

folding the first panel over the third panel;

adhering the first panel to the spacer portions thereby to generally form an envelope inside of which the slider portion may be moved to thereby selectively reveal a portion of the advertising information on the second panel through both the envelope and slider window.

The advertising device and respective blank described herein provide a variety of print surfaces upon which to display advertising, is simple and entertaining to use, easy to manufacture, and straightforward to assemble. The advertising device described herein provides the user with the ability to selectively reveal different portions of an overall advertising message.

### BRIEF DESCRIPTION OF THE DRAWINGS

Embodiments will now be described more fully with reference to the accompanying drawings, in which:

FIG. 1 is an elevation view of an advertising device with a slider in a first position;

FIG. 2 is an elevation view of the advertising device of FIG. 1 with the slider between first and second positions;

FIG. 3 is an elevation view of the advertising device of FIG. 1 with the slider in a second position;

FIG. 4 is an elevation view of one side of a foldable, one-piece blank for the advertising device of FIG. 1; and

FIG. 5 is an elevation view of the opposite side of the foldable, one-piece blank of FIG. 4.

### DETAILED DESCRIPTION OF THE EMBODIMENTS

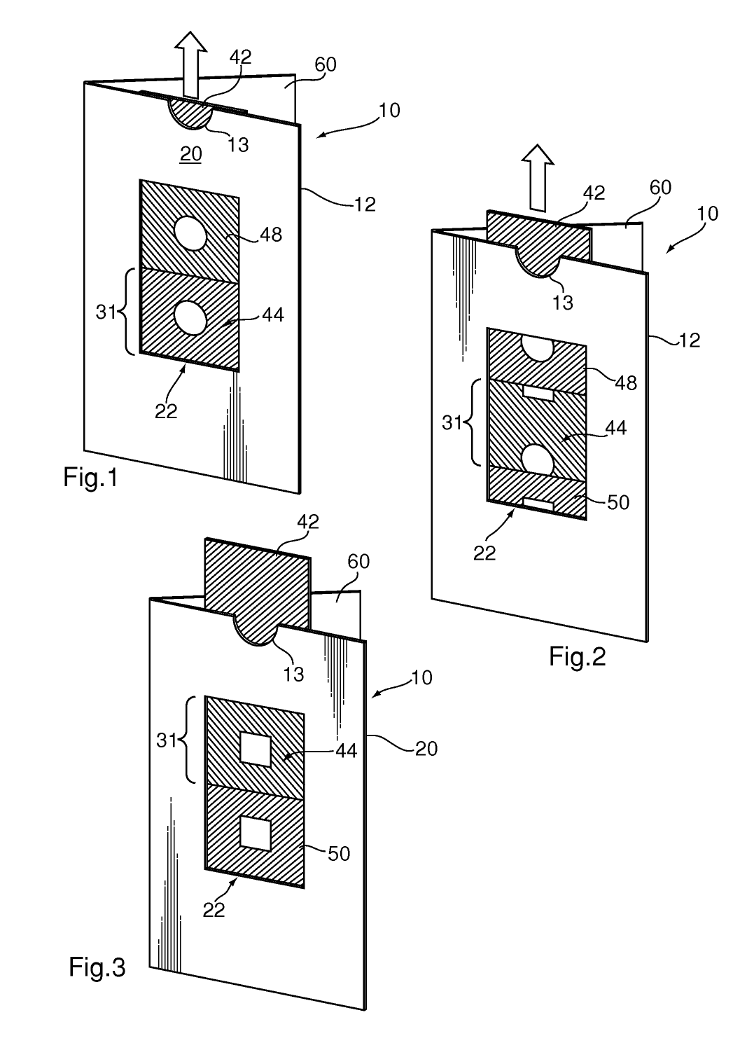

FIGS. 1 to 3 are elevation views of an advertising device 10 according to an embodiment of the invention. Turning to FIG. 1, advertising device 10 includes an envelope 12 having a front/first panel 20 and a back/second panel 30 (shown in later Figures). Front panel 20 includes an envelope window 22 that is dimensioned to reveal first advertising information 32 on an interior wall of back panel 30. Only a portion 31 of first advertising information 32 is viewable through envelope window 22 at any particular time due to the dimensions of a slider portion 42 (“slider”). More particularly, slider 42 has a slider window 44 that is dimensioned to reveal only a portion 31 of the first advertising information 32 depending upon the position of slider 42 in envelope 12. According to an embodiment, this portion is approximately half, or 50 percent such that only about 50 percent of the first advertising information 32 is revealed at any given time. Slider 42 is slidably disposed in envelope 12, and moveable by a user of the advertising device between first and second positions.

Envelope 12 of advertising device 10 includes a cutaway 13 at its open end that is sized suitably for gripping slider 42 between a user's thumb and forefinger for pulling and pushing slide 42 relative to envelope 12, as will be described.

Slider includes a first information surface 48 and a second information surface 50 suitable for printing information thereon. In the first position as shown in FIG. 1, first information surface 48 is viewable through the envelope window, whereas second information surface 50 is not. In the second position as shown in FIG. 3, second information surface 50 is viewable through the envelope window whereas first information surface 48 is not. As shown in FIG. 2, where slider 42 is intermediate the first and second positions, a portion of each of the first and second information surfaces 48, 50 is viewable.

According to an embodiment, first information surface 48 carries information that relates to the portion 31 of the first advertising information 32 that is viewable when slider 42 is in the first position. This situation is illustrated in FIG. 1 where slider 42 is in the first position, with a circle representing the viewable portion 31 of the first advertising information 32 and a circle is shown on first information surface 48. Similarly, it may be that second information surface 50 carries information that relates to the portion 31 of the first advertising information 32 that is viewable when slider 42 is in the second position. This situation is illustrated in FIG. 3 wherein slider 42 is in the second position, with a square representing the viewable portion 31 of the first advertising information 32 and a square shown on the second information surface 50.

According to the embodiment shown, advertising device 10 includes an auxiliary advertising panel 60 connected to an edge of envelope 12. Auxiliary advertising panel 60 may carry further advertising information that suits the object of advertising device 10.

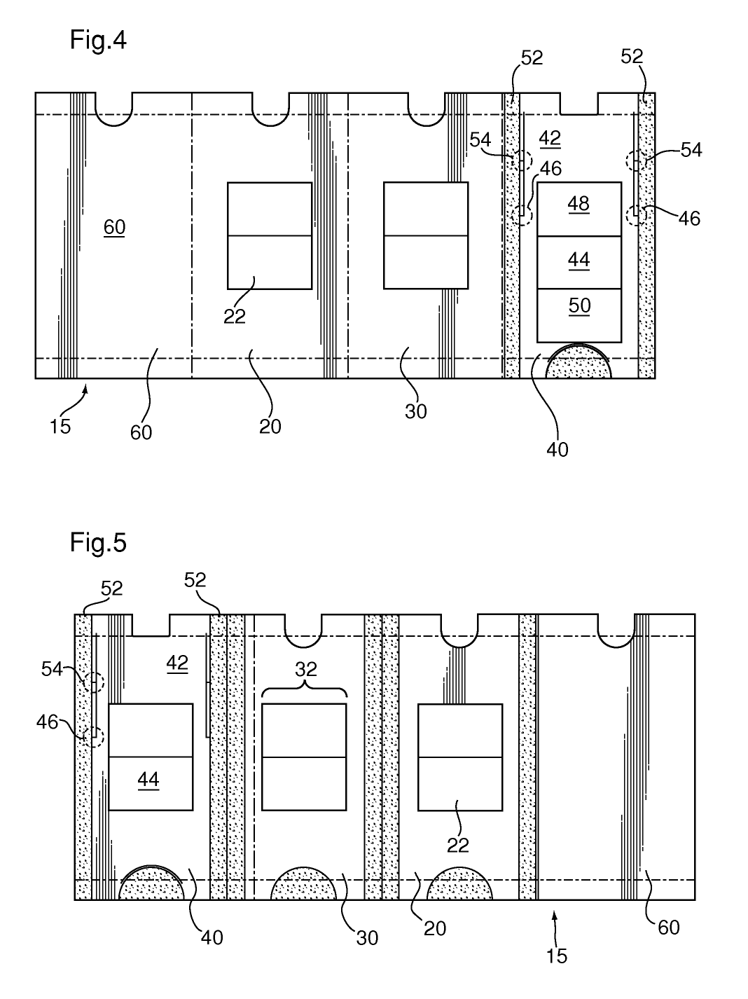

FIGS. 4 and 5 are elevation views of respective sides of a foldable, one-piece blank 15 for advertising device 10 shown in FIGS. 1 through 3. Blank 15 is formed from a printed press sheet by die cutting using an auto platten die cutter from a single piece of card stock with interconnected panels as will be described. The interconnected panels have advertising surfaces for display of text, images, logos and other advertising or information.

Blank 15 includes a first generally rectangular panel 20 corresponding to first/front panel 20 shown in FIG. 1. First panel 20 has a first end edge and a second end edge opposite the first end edge, and the envelope window 22 therethrough. Blank 15 also includes a second generally rectangular panel 30 corresponding to second/back panel 30 referred to above that has a first end edge connected to the second end edge of the first panel 20 by a fold line, and a second end edge. The first advertising information 32 is shown printed on the side of second panel 20 that corresponds to the inside wall of the envelope 12 to be formed from the first and second panels 20, 30.

Blank 15 also includes a third rectangular panel 40 having a first end edge connected to the second end edge of the second panel 30 by a fold line, and a second end edge. Third panel 40 includes slider 42 disposed between two spacer portions 52. Slider 42 remains temporarily coupled to spacer portions 52 at its top and bottom ends, but is cut along the periphery of its midsection to simplify assembly. Slider window 44 of slider portion 42 can be seen in FIGS. 4 and 5. Slider 42 is adapted to be decoupled from spacer portions 54 during manufacture of the advertising device, as will be described below. It can be seen that the first, second and third panels 20, 30, 40 have corresponding exterior dimensions such that they can be folded together in such a manner as to generally form envelope 12.

Also shown in FIGS. 4 and 5 are slider shoulders 46 of slider 42, and spacer shoulders 54 of spacer portions 54, each at their respective peripheries. When blank 15 has been formed into advertising device 10, the slider shoulders 46 are positioned relative to spacer shoulders 54 in order to butt against spacer shoulders 54 at the second slider position thereby to prevent removal by a user of slider 42 entirely from envelope 12.

Auxiliary panel 60 can be seen connected to the first end edge of first panel 20 by a fold line.

According to this embodiment, the panels 20, 30, 40 of blank 15 are formed of card stock in which the fold lines are creases in the card stock.

It will be understood that the hash marks in FIGS. 1 through 3 between slider 42 and envelope 12 are for providing a distinction between the two parts of advertising device 10, whereas the hash marks in FIGS. 4 and 5 identify glue lines for assembling the advertising device 10 from blank 15 during manufacture.

After blank 15 has been formed, advertising device 10 may be formed from blank 15. During forming of advertising device 10, the die cut blank 15 is provided to a folder/gluer machine for construction. Adhering means such as glue is applied in the areas shown in FIGS. 4 and 5. It will be understood that the overall finished size of blank 15 will dictate the number of passes required by the folder/gluer at the assembly stage.

During assembly/formation of advertising device 10, slider portion 42 is decoupled from spacer portions 52 by cutting blank 15 along upper and lower trim lines as shown in FIGS. 4 and 5 to sever connections with spacer portions 52 entirely. Once slider 42 is decoupled, the remainder of third panel 40 (i.e. the spacer portions 52) is folded over and adhered to second panel 30. First panel 20 is then folded over and adhered to spacer portions 52 with slider 42 therebetween to complete formation of the envelope 12 with slider 42 inside. Slider 42 is slidably positioned within envelope to enable a user to selectively reveal a portion 31 of the first advertising information 32 on second panel 30 through both the envelope window 22 and the slider window 44.

It will be understood that depending upon the requirements of the application for advertising device 10, there may be no auxiliary information panels 60, one auxiliary information panel 60, or several. Optionally, an auxiliary information panel 60 may be connected by a perforated line, or “perf”, to facilitate, for example, use of auxiliary information panel 60 as a tear-away business reply card.

While preferably the advertising device 10 and corresponding blank 15 are formed of card stock, it will be understood that other materials such as corrugate may be used. It is also conceivable that plastics of certain types may be used in more specialized applications.

Although embodiments have been described, those of skill in the art will appreciate that variations and modifications may be made without departing from the spirit and scope of the invention defined by the appended claims.

What is claimed is:

1. An advertising device comprising:
an envelope having a front panel and a back panel, the front panel including an envelope window dimensioned to reveal first advertising information on an interior wall of the back panel;
a slider slidably disposed in the envelope and having a slider window dimensioned to reveal only a portion of the first advertising information depending upon its position in the envelope;
wherein the slider is moveable by a user of the advertising device.

2. The advertising device of claim 1, wherein the slider window is about half of the size of the envelope window.

3. The advertising device of claim 1, wherein the slider is moveable between a first position and a second position in the envelope.

4. The advertising device of claim 3, wherein the slider includes first and second advertising information surfaces, the first information surface fully viewable through the envelope window only when the slider is in the first position and the second information surface fully viewable through the envelope window only when the slider is in the second position.

5. The advertising device of claim 4, wherein the first information surface carries information that relates to the portion of the first advertising information that is viewable when the slider is in the first position.

6. The advertising device of claim 4, wherein the second information surface carries information that relates to the portion of the first advertising information that is viewable when the slider is in the second position.

7. The advertising device of claim 1, further comprising an auxiliary advertising panel connected to an edge of the envelope.

8. The advertising device of claim 1, wherein the envelope comprises a cutaway dimensioned to permit a user to grip the slider for sliding.

9. The advertising device of claim 1, wherein the slider comprises shoulders along its periphery that are dimensioned to butt against respective shoulders in the envelope thereby to prevent removal by a user of the slider entirely from the envelope.

10. An elongate, foldable blank for an advertising device, comprising:
a first generally rectangular panel having a first end edge and a second end edge opposite the first end edge, the first panel having an envelope window therethrough;
a second generally rectangular panel having a first end edge connected to the second end edge of the first rectangular panel by a fold line, and a second end edge, the second panel having advertising information thereon;
a third rectangular panel a first end edge connected to the second end edge of the second rectangular panel by a fold line, and a second end edge, the third panel comprising a slider portion disposed between two spacer portions, the slider portion having a slider window and adapted to be decoupled from the spacer portions during manufacture of the advertising device;
wherein the first, second and third panels have corresponding exterior dimensions and are adapted to be folded together in such a manner as to generally form an envelope inside of which the slider portion may be moved to thereby selectively reveal a portion of the advertising information on the second panel through both the envelope and slider windows.

11. The blank of claim 10, wherein the respective fold lines connecting the panels are creases.

12. The blank of claim 10, further comprising at least one auxiliary panel connected to the first end edge of the first panel by a fold line.

13. The blank of claim 10, wherein the panels are formed of a card stock.

14. A method of manufacturing an advertising device, comprising:
providing an elongate, foldable blank comprising:
a first generally rectangular panel having a first end edge and a second end edge opposite the first end edge, the first panel having an envelope window therethrough;
a second generally rectangular panel having a first end edge connected to the second end edge of the first rectangular panel by a fold line, and a second end edge, the second panel having advertising information thereon;
a third rectangular panel a first end edge connected to the second end edge of the second rectangular panel by a fold line, and a second end edge, the third panel comprising a slider portion disposed between two spacer portions, the slider portion having a slider window;
decoupling the slider portion from the spacer portions;
folding the third panel over the second panel including
adhering the spacer portions to the second panel;
folding the first panel over the third panel;
adhering the first panel to the spacer portions thereby to generally form an envelope inside of which the slider portion may be moved to thereby selectively reveal a portion of the advertising information on the second panel through both the envelope and slider window.

15. The method of claim 14, wherein the decoupling comprises cutting the blank along upper and lower trim lines to free the slider portion from the spacer portions.
